(19) United States
(12) Patent Application Publication
(10) Pub. No.: US 2004/0204178 A1
(43) Pub. Date: Oct. 14, 2004

(54) Wireless telephone charging adapter

(76) Inventor: John Ernest Elwart, Playa Del Rey, CA (US)

Correspondence Address: John Ernest Elwart, P.O. Box 5342, Playa Del Rey, CA, 90296, US

(21) Appl. No.: 10/187,439

(22) Filed: Jul. 2, 2002

(51) Int. Cl. H04B 1/38; H04M 1/00

(52) U.S. Cl. 455/573; 455/90.1

(57) ABSTRACT

This disclosure is directed to a wireless telephone charging adapter whereby the connecting parts are threaded. The threaded portions are aligned by positioning the starting point of two pairs of two threads. This device is connected is the same manner as the tightening of a screw to a nut. The aligned positioning of the threaded starting point enables the synchronized engagement of the two pairs of threads whereby in one half to one full turn, all four threaded units are simultaneously engaged. This disclosure also provides for reverse threads, inclined threads, machine threads and the like.

### FIELD OF THE INVENTION

The present invention relates to wireless telephone adapters used connectably to be inserted into the telephone chassis for the purpose of charging the battery. This invention involves both the external adapter and the relevant internal parts of the adapter. In particular, the present invention relates to an adapter whereby the adapter has threaded connectors. Breifly, the adapter threaded connectors are a double male pair and a double female pair, each pair separated by a centering electrical isolator. The thread pitch of both pairs are the same, the diameter of the outer threads are larger, the inner diameter is smaller. The starting of each thread of each pair of threads is aligned to cause the engagement of each pair of two threads to be in synchronization with its counterpart. This is accomplished by the horizontal positioning of each pair of threads to the other pair at the starting point. Engaging the two pairs is accomplished by turning one half to one turn clockwise, or in reverse thread, one half to one turn anti-clockwise. All four threads will engage simultaneously.

### SUMMARY OF THE INVENTION

The wireless telephone charging adapter of the present invention provides a secure torque tight connection to enable the user to charge the wireless telephone and not have to watch the telephone screen to see if it is charging or not. The threaded connection of the present invention leaves it up to the user to tighten up the connector to whatever torque level he or she feels comfortable with. The user now has control over the securing of the charging connection to the battery charger.

At present the existing charging adapters do not fit the demands of the consumer. Verizon Wireless has an adapter with a claw and push button spring loaded assembly that works and does not always work. Motorola uses the conventional Motorola plug which works great for a few months, then the user feels juxtapositioned into cleaning the outside male plug with solvents to get a better connection. Ericsson probably, has the most reliable adapter fitting plug, but if one of the plastic plug connectors break, the consumer is out of luck.

If, at this time a proper adapter existed it would be certainly apparent. In a supporting statement, in the 1960's the common adapter for a guitar amplifier was an RCA adapter and it was in every guitar and amplifier for at least 30 years.

The present invention has created the first synchronized thread assembly. The name synchronized thread is the result of the activity of two threads. The design of the present invention shows two separate threads arriving at the same location at the same time. These two threads are separated by a centering electrical isolator, which keeps positive electrical charge insulated from negative charge. As previously mentioned, the two male threads engage the female threaded portion of the adapter at the same interval because the male threads are aligned at the start of the first thread of each male portion. The starting of both male assembly threads is positioned whereby the two threads engage to the synchronized female counterpart simultaneously. In effect, one half or one turn connects four threaded connectors at the same time.

Another benefit of the present invention is the screw assembly in that if grease, dirt, condensation or corrosion get into the connector, the torque from screw tightening is still stronger than a claw, spring loaded connectors, a Motorola plug, a banana plug, or even an Ericsson adapter. It might be possible to torque past the corrosion.

Consumers have no recourse to control the effects of such lame products when they go bad. All they can do is get a replacement, which sometimes is no longer available. It might be necessary to buy a new telephone.

A still further benefit of the present invention is the screw assembly. Now for the first time the center pin of an electrical connector is threaded. This will create a stronger connection to the positive pole. Unlike the traditional banana connector which loses its tension, the present invention cannot wiggle loose. It must be unscrewed.

The type of threads usable in the present invention can be of any small machine thread commonly used for video cable connections or the like. The inner thread being physically smaller must be of the same pitch as the larger outside thread in order to perform properly.

### BRIEF DESCRIPTION OF THE DRAWINGS

FIG. 1 shows a perspective view of the wireless telephone charging adapter of the present invention.

### DETAILED DESCRIPTION OF THE INVENTION

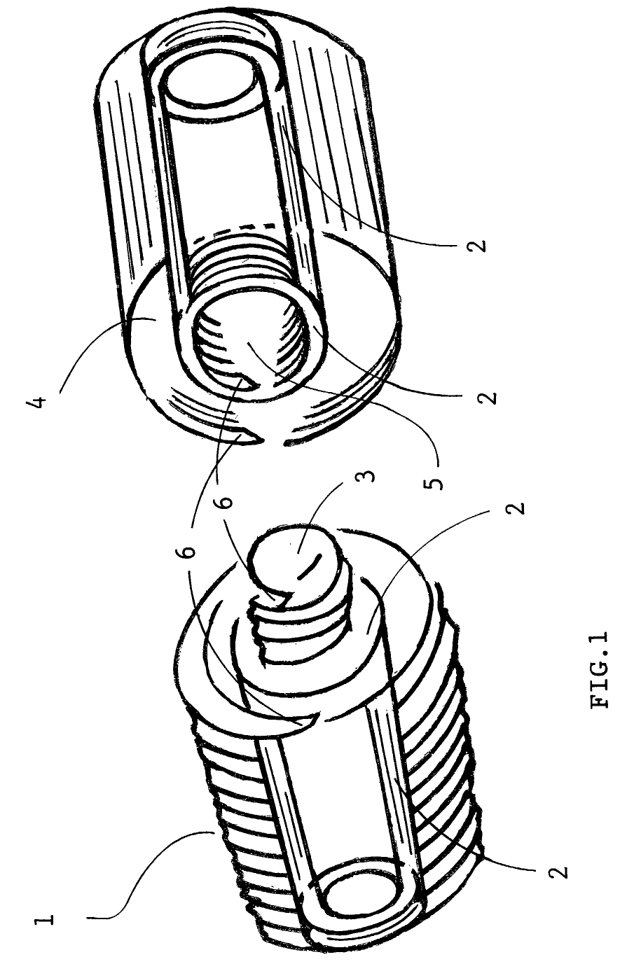

Referring to FIG. 1, the adapter of the present invention has a male exterior thread 1, which is a hollow threaded tube. Inserted in its hollow cavity is isolator 2, which is a non electrically conductive material and is a hollow tube. Inserted into isolator 2 is male threaded shaft 3, which is a positive electrical conductor and male exterior thread 1 is a negative, or ground carrier. Female exterior coupler 4, is a negative, or ground carrier, which is threadably engaged to 1 by turning clockwise one half to one turn, or in case of reverse threading, anti-clockwise. Isolator 2, also is inside of 4 and performs the same functions as its initial location in 1. Female threaded shaft 5 is mounted inside the isolator 2 in the same manner as male threaded shaft 3 and 5 is a positive electrical conductor and a threadably engagable counter part to 3.

Common to both units is synchronized threading position 6, whereby both units are threadably engaged by a simple half turn or as much as a full turn. All four threaded parts; 1,3,4 and 5 are simultaneously threadably connected by the present invention.

I claim:

1. A wireless telephone charging adapter comprising;
a threaded hollow cylindrical tube having exterior threading and of an electrically conductive material, said tube means for housing corresponding parts;
a non-threaded hollow cylindrical tube of an electrically non conductive material and insertable to said threaded hollow cylindrical tube;
a partially threaded shaft, threadably at the front end and non threadably after the front end to the rear, and of an electrically conductive material and of a solid mass and insertable to said non-threaded hollow cylindrical tube;
said threaded shaft wherein the thread is an exterior male thread;
a threaded hollow cylindrical tube having interior threading and of an electrically conductive material, said tube means for housing corresponding parts;
a non-threaded hollow cylindrical tube of an electrically non conductive material and insertable to said threaded hollow cylindrical tube having interior threads;
a partially threaded shaft, threadably at the front end and non threadably after the front end to the rear, and of an electrically conductive material and of a solid mass and insertable to said non-threaded hollow cylindrical tube;
said threaded shaft wherein the thread is an interior female thread.

2. The wireless telephone charging adapter of claim 1, wherein all threaded components engage simultaneously.

3. The wireless telephone charging adapter of claim 2, wherein a synchronized thread position of all threaded components;
means for providing all threaded components to engage simultaneously.

4. A wireless telephone charging adapter comprising;
a set of four threaded components to provide electrical contact to a source of electricity and to enable the charging of a wireless telephone battery;
said components by the design of positioning the starting point of threads to engage;
means to provide the simultaneous engagement of threaded components as an electrical adapter to provide connecting power to a wireless telephone battery.

5. The wireless telephone charging adapter of claim 4, wherein said threaded components operate to simultaneously engage by synchonized positioning.

6. The wireless telephone charging adapter of claim 5 wherein said synchronized positioning operates with threads of the same pitch.

7. The wireless telephone charging adapter of claim 6, wherein said threads of the same pitch are simultaneously engagable by connecting any size thread of the same pitch to the same pitch of the same thread.

8. The wireless telephone charging adapter of claim 7 wherein any size thread of the same pitch is assembled by synchronized positioning of the starting point of the threads.

9. The wireless telephone charging adapter of claim 8, wherein said thread is a clockwise thread or a anticlockwise thread.

10. The wireless telephone charging adapter of claim 9, wherein all types of threads, machine, screw and reverse and inclined threads are simultaneouly engaged by the synchronized positioning of the threads at the starting point.
